(19) United States
(12) Patent Application Publication
(10) Pub. No.: US 2010/0282929 A1
(43) Pub. Date: Nov. 11, 2010

(54) Sucker assembly with helical spring

(76) Inventor: Ming-Kun Lee, Taipei City (TW)

Correspondence Address: Ming-Kun, Lee, 11F, No. 156, Sec 1, Jianguo N. Rd.,, Taipei City, 104, TW

(21) Appl. No.: 12/387,813

(22) Filed: May 8, 2009

(51) Int. Cl. F16B 47/00; F16M 13/02

(52) U.S. Cl. 248/205.5

(57) ABSTRACT

A sucker assembly having a helical spring is provided. The sucker assembly includes a sucking disk and the helical spring. In use, when an external force is applied to the sucking disk against an external surface, the helical spring is pressed simultaneously, so that the helical spring gives a counterforce to the sucking disk, thereby improving adhesion between the sucking disk and the external surface.

### BACKGROUND OF THE INVENTION

1. Technical Field

The present invention relates to suckers and, more particularly, to a sucker assembly with a helical spring to provide enhanced adhering effect when attached to an external surface.

2. Description of Related Art

Suckers, also known as sucking discs, have been extensively used in our daily life to work with hooks, hanging rods, and decorations. There are also industrial suckers serve to attach objects with smooth surfaces and difficult to grab, such as building blocks, glass curtains, tiles, metal boards and molds for facilitating transportation of these objects. In short, suckers are useful accessories for hanging or positioning objects. The conventional suckers typically function in virtue of the atmospheric pressure. That is, when a sucker is pressed against a smooth surface of an object, air in the sucker is expelled out. At this time, since pressure in the sucker is smaller than the external atmospheric pressure, the atmospheric pressure helps to press the sucker against the surface. However, the adhering effect of such conventional sucker is defective. After a term of use, the adhering effect tends to be gradually compromised by the weight of the object it supports or the invasion of external moisture and finally become invalid, causing the object it supports to fall down to the ground. Therefore, the conventional suckers are unreliable and thus likely to being safety concerns to the objects they support and in turn to the users thereof.

### SUMMARY OF THE INVENTION

The primary objective of the present invention is to provide a sucker assembly with a helical spring, wherein the sucker assembly includes a sucking disk and the helical spring. For attaching the sucking disk to an external object or a smooth surface, an external force is applied to the sucking disk so that the sucking disk deforms and presses the helical spring. Then the helical spring gives a counterforce to the sucking disk, thereby improving adhesion between the sucking disk and the external object or the smooth surface.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawings, wherein:

FIG. 1 is a perspective view of a sucker assembly with a helical spring according to the present invention;

FIG. 2 is an exploded view of the sucker assembly of the present invention;

FIG. 3 is a first schematic drawing showing application of the sucker assembly according to the present invention;

FIG. 4 is a second schematic drawing showing application of the sucker assembly according to the present invention;

FIG. 5 is a third schematic drawing showing application of the sucker assembly according to the present invention;

FIG. 6 is a fourth schematic drawing showing application of the sucker assembly according to the present invention; and

FIG. 7 is a fifth schematic drawing showing application of the sucker assembly according to the present invention.

### DETAILED DESCRIPTION OF THE PREFERRED EMBODIMENT

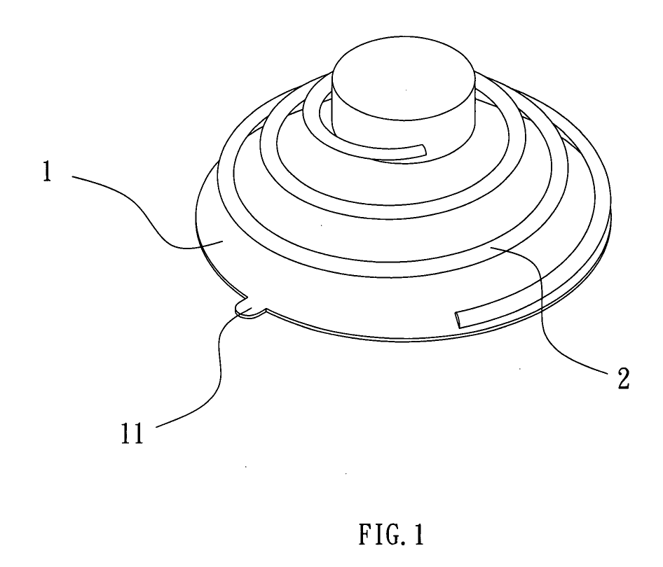

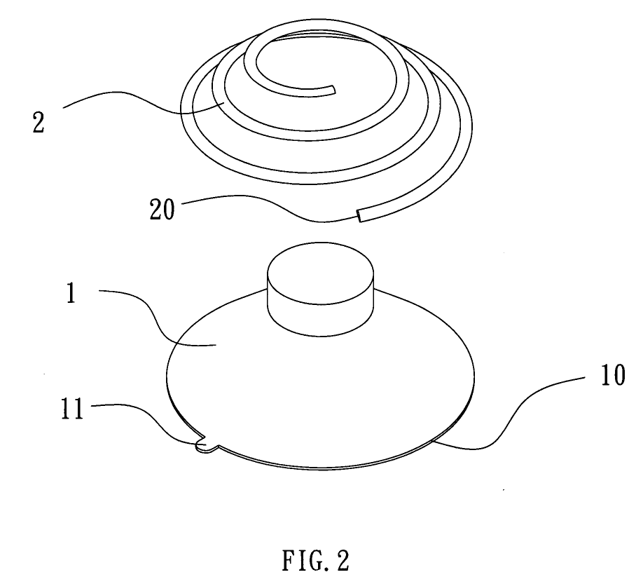

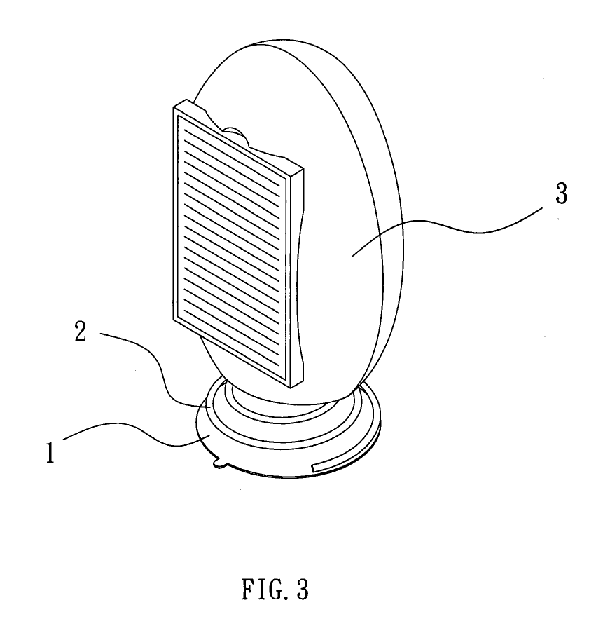

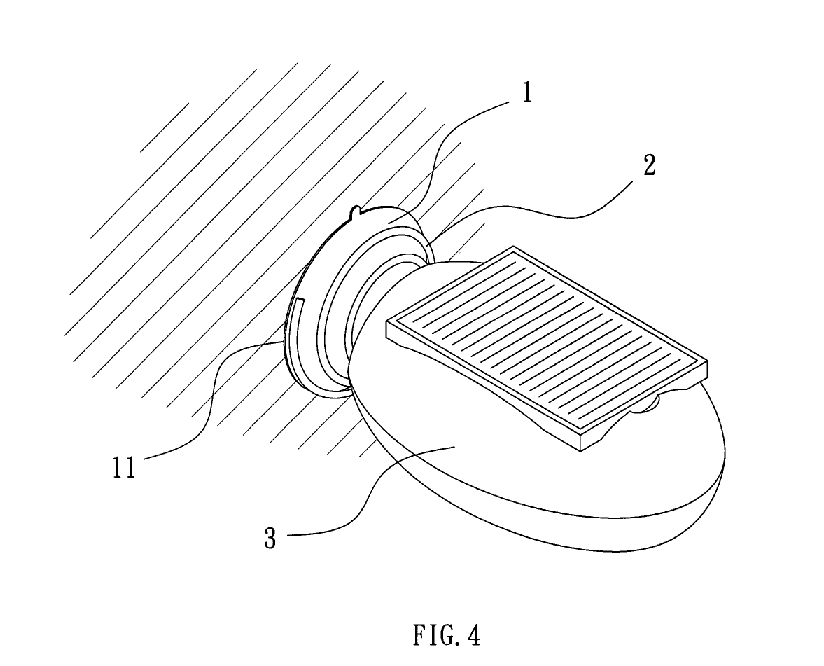

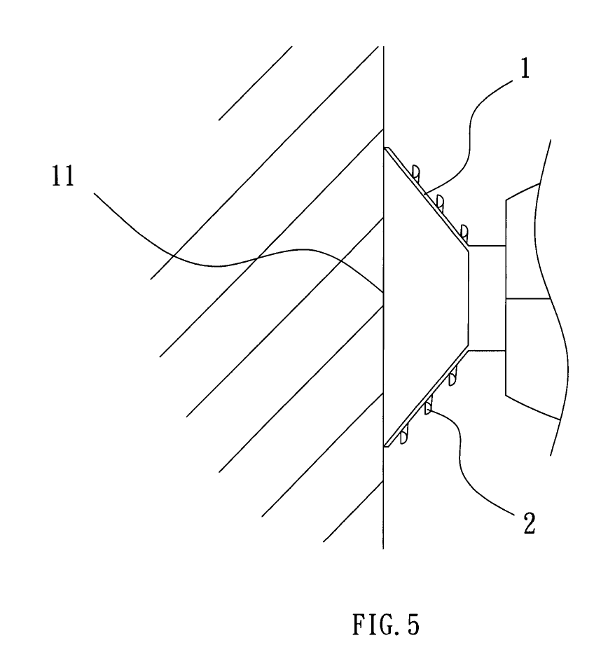

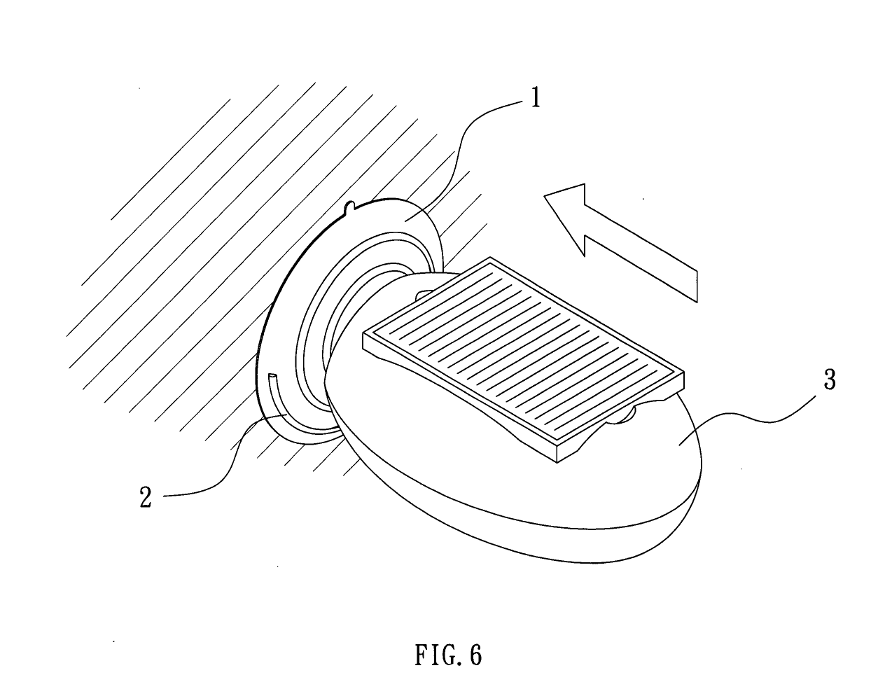

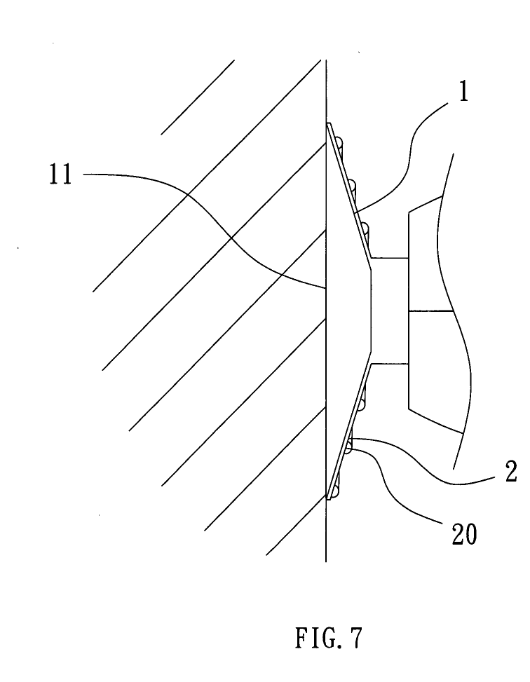

Please refer to FIGS. 1 and 2 for the perspective view and exploded view of a sucker assembly with a helical spring disclosed in the present invention. The sucker assembly primarily comprises a sucking disk 1 and the helical spring 2. The sucking disk 1 is formed with an adhesion surface 10. A pulling ear 11 is formed near a periphery of the sucking disk 1. The helical spring 2 mounted around an outer surface of the sucking disk 1 reverse to the adhesion surface 10 has a contacting surface 20. Please refer to FIGS. 3, 4, 5, 6, and 7 for applied drawings of the sucker assembly according to the present invention. As can be seen in the drawings, the sucking disk 1 is connected with an object 3 to be hung. For attaching the object 3 to a smooth external object or a wall, it is firstly to make the sucking disk 1 abut upon the external object or wall and then apply an external force to press the sucking disk 1. When the sucking disk 1 deforms under the external force, air in the sucking disk 1 is expelled out. At this time, since pressure in the sucking disk 1 is smaller than the external atmospheric pressure, the atmospheric pressure helps to press the sucking disk 1 against the external object or wall firmly. Besides, when the external force is applied to the sucking disk 1, the helical spring 2 mounted around the outer surface of the sucking disk 1 is pressed simultaneously. As this time, the contacting surface 20 abuts against the outer surface of the sucking disk 1 so that a counterforce out of deformation of the helical spring 2 further presses the sucking disk 1 against the external object or wall. Consequently, adhesion between the sucking disk 1 and the external object or wall is enhanced and the sucking disk 1 is less likely coming off the external object or wall unintentionally. On the other hand, it is easy to detach the sucking disk 1 from the external object or wall by pulling the pulling ear 11.

What is claimed is:

1. A sucker assembly with a helical spring, the sucker assembly comprising:
a sucking disk;
a helical spring, mounted around an outer surface of the sucking disk;
whereby when the sucker assembly is pressed upon an external object, the sucking disk is deformed under pressure and presses the spring element so that the spring element gives a counterforce to the sucking disk and further presses the sucking disk toward the external object.

2. The sucker assembly of claim 1, wherein a pulling ear is formed near a periphery of the sucking disk.

3. The sucker assembly of claim 1, wherein the helical spring has a contacting surface.
